(19) United States
(12) Patent Application Publication
(10) Pub. No.: US 2023/0410157 A1
(43) Pub. Date: Dec. 21, 2023

(54) TRANSFORMATION OF RETURN CONTENT USING ARTIFICIAL INTELLIGENCE

(71) Applicant: International Business Machines Corporation, Armonk, NY (US)

(72) Inventors: Nosaiba Dar Mousa, Wappingers Falls, NY (US); Karl Owen Casserly, Valley Stream, NY (US); Warren Boldrin, Montgomery, NY (US)

(21) Appl. No.: 17/807,817

(22) Filed: Jun. 20, 2022

(51) Int. Cl. G06Q 30/02; G06Q 10/08

(52) U.S. Cl. CPC G06Q 30/0278; G06Q 30/0281; G06Q 10/0875

(57) ABSTRACT

Provided is a computer-implemented method, system, and computer program product for transforming return content to new content using artificial intelligence. A processor may collect identification data associated with a returned configurable product. The processor may analyze the identification data to determine attributes associated with each component of the returned configurable product. The processor may generate, based on the analyzing, a components list comprising reusable components from the returned configurable product. The processor may analyze the components list to identify similarities between the attributes of each reusable component and attributes of a plurality of current components. The processor may generate, based on the identified similarities, a component matrix, wherein at least one reusable component is grouped with at least one current component. The processor may initiate manufacturing of a second configurable product using the at least one reusable component from the component matrix.

### BACKGROUND

The present disclosure relates generally to the field of artificial intelligence and, more specifically, to transforming return content to new content using data analytics.

Product returns are a commonplace occurrence in many industries. Typically, a customer may return a product because of defects, product age, and/or availability of newer versions of the product. In many instances, the returned product may include product content that may still be operable. However, the returned product content may be discarded without assessing operability.

### SUMMARY

Embodiments of the present disclosure include a computer-implemented method, system, and computer program product for transforming return content to new content using artificial intelligence. A processor may collect identification data associated with a returned configurable product. The processor may analyze the identification data to determine attributes associated with each component of a plurality of components of the returned configurable product. The processor may generate, based on the analyzing, a components list comprising a plurality of reusable components from the returned configurable product. The processor may analyze the components list to identify similarities between the attributes of each reusable component of the plurality of reusable components and attributes of a plurality of current components. The processor may generate, based on the identified similarities, a component matrix, wherein at least one reusable component is grouped with at least one current component. The processor may initiate manufacturing of a second configurable product using the at least one reusable component from the component matrix.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example returned product transformation system, in accordance with some embodiments of the present disclosure.

FIG. 2 illustrates example model layers for processing the returned configurable product, in accordance with some embodiments of the present disclosure.

FIG. 3A illustrates an example diagram for processing the returned configurable product, in accordance with some embodiments of the present disclosure.

FIG. 3B illustrates an example diagram of the transformation layer for processing the identified reusable components of the returned configurable product, in accordance with some embodiments of the present disclosure.

FIG. 4 illustrates an example machine type and model listing of various generations of configurable products over time, in accordance with some embodiments of the present disclosure.

FIG. 5A illustrates an example diagram of generating a components list using two different configurable products, in accordance with some embodiments of the present disclosure.

FIG. 5B illustrates an example diagram of generating a component matrix, in accordance with some embodiments of the present disclosure.

FIG. 6 illustrates an example process for transforming return content into new content, in accordance with some embodiments of the present disclosure.

FIG. 7 illustrates a high-level block diagram of an example computer system that may be used in implementing one or more of the methods, tools, and modules, and any related functions, described herein, in accordance with embodiments of the present disclosure.

FIG. 8 depicts a cloud computing environment in accordance with embodiments of the present disclosure.

FIG. 9 depicts abstraction model layers in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of artificial intelligence and, more particularly, to transforming return content to new content using data analytics. While the present disclosure is not necessarily limited to such applications, various aspects of the disclosure may be appreciated through a discussion of various examples using this context.

Product returns are a commonplace occurrence in many industries. Typically, a customer may return a product because of defects, product age, and/or availability of newer versions of the product. In many instances, the returned product may include product content that may still be operable. Typically, the returned product content may be discarded without assessing operability.

Embodiments of the present disclosure include a computer-implemented method, system, and program product for identifying reusable components from returned configurable products and reusing those components to generate new configurable products. For example, reusable components may be used for both manufacturing and remanufacturing of configurable products. In this way, the system may be used to reduce production of new components while increasing manufacturing profits. Further, the system reduces human interaction and/or operational costs associated with identification, validation, counting, and locating reusable components of returned configurable products by automating these various processes.

In embodiments, the system may collect identification data associated with a returned configurable product. The returned configurable product may be any type of product such as a computer system, server, mainframe, etc. that comprises a plurality of configurable components. The identification data may be received from a return processing system that processed the returned configurable product. For example, the returned configurable product may be a mainframe computer that has multiple configurable components (e.g., memories, processors, microprocessors, etc.) that were designed for a specific client.

In embodiments, the system may analyze the identification data to determine attributes associated with each component of a plurality of components of the returned configurable product. In some embodiments, attributes may include any type of identifying information such as a serial number, a feature code, a part number, a description of the component, a version, a generation value, and/or a function of the component. In embodiments, analyzing the identification data may be performed using natural language processing. For example, unstructured textual data from one or more electronic documents associated with the components of the returned configurable product may be received and analyzed to determine identification of the various attributes. For example, various manuals, handbooks, configuration setups, etc., may be analyzed by natural language processing to identify the given attributes. In some embodiments, metadata associated with the returned configurable product may also be analyzed to identify the attributes of each of the components.

In embodiments, the system may generate, based on the analyzing, a components list comprising a plurality of reusable components from the returned configurable product. In some embodiments, location data for each reusable component may be generated for the components list. This location data may be used to track the inventory location of where the reusable components are stored after processing. Further, the components list may include a quantity of each component. This allows the system to identify how many reusable/current components are available for generating new products or repurposed products at any given time.

In some embodiments, generating the components list may include querying a product data source to determine component requirements for generating a second configurable product, analyzing the attributes associated with each component of the plurality of components of the returned configurable product, and comparing the attributes associated with each component to a component requirement threshold to identify the plurality of reusable components. The component requirement threshold may be based on various business rules and/or a carryforward list. For example, the system may only track reusable components from the returned configurable product based on business needs. In some embodiments, components that are identified as not reusable may not be tracked.

In embodiments, the system may analyze the components list to identify similarities between the attributes of each reusable component of the plurality of reusable components and attributes of a plurality of current components. In embodiments, the plurality of current components may be other components held in a return inventory or a current inventory. For example, the plurality of current components may include at least one reusable component of a second returned configurable product (other product returns), a new manufactured component, or both. In embodiments, similarities between attributes such as feature code, part number, description of the component, function of the component may be compared. For example, the feature code of each reusable component may be compared to a second feature code of each current component (or other returned components) of the components list and any matching feature codes may be identified.

In embodiments, the system may generate, based on the identified similarities, a component matrix, wherein at least one reusable component is grouped with at least one current component. In embodiments, the component matrix may group components by structural similarities. In some embodiments, grouped components may be merged based on their similarities. For example, a first attribute of at least one reusable component may be modified to a second attribute of at least one current component based on matching feature codes. For example, the first attribute may be a first part number and the second attribute may be a second part number. In this way, reusable components that may have different/older/expired part numbers but belong in the same feature code or structural family group may have their part numbers automatically transformed to current part numbers. In this way, the system transforms the attributes of older reusable components to newer or current attributes. This allows the system to easily identify the availability of all components in inventory used for generating new configurable products.

In embodiments, the system may initiate manufacturing (or remanufacturing) of a second configurable product using at least one reusable component from the component matrix. For example, the system may generate a new configurable product using at least one reusable component from the returned configurable product. In this way, the system may utilize various reusable components from returned configurable products in order to reduce manufacturing costs.

The aforementioned advantages are example advantages, and not all advantages are discussed. Furthermore, embodiments of the present disclosure can exist that contain all, some, or none of the aforementioned advantages while remaining within the spirit and scope of the present disclosure.

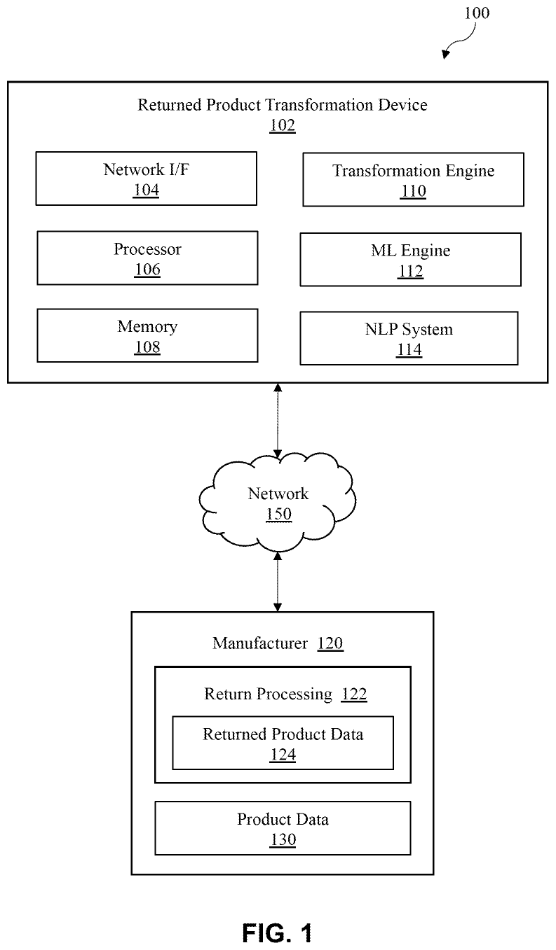

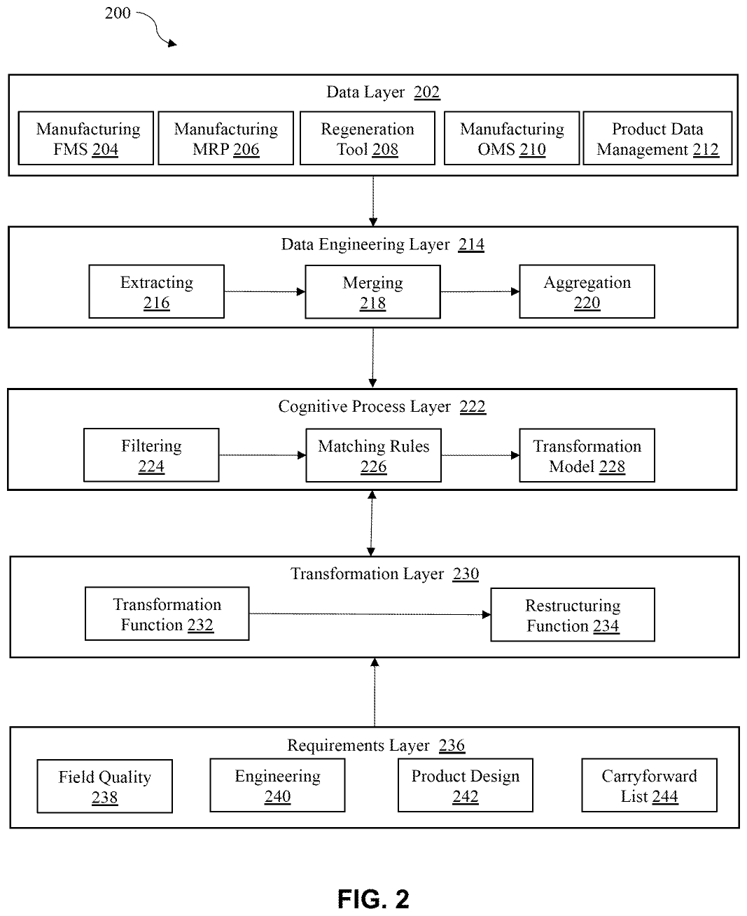

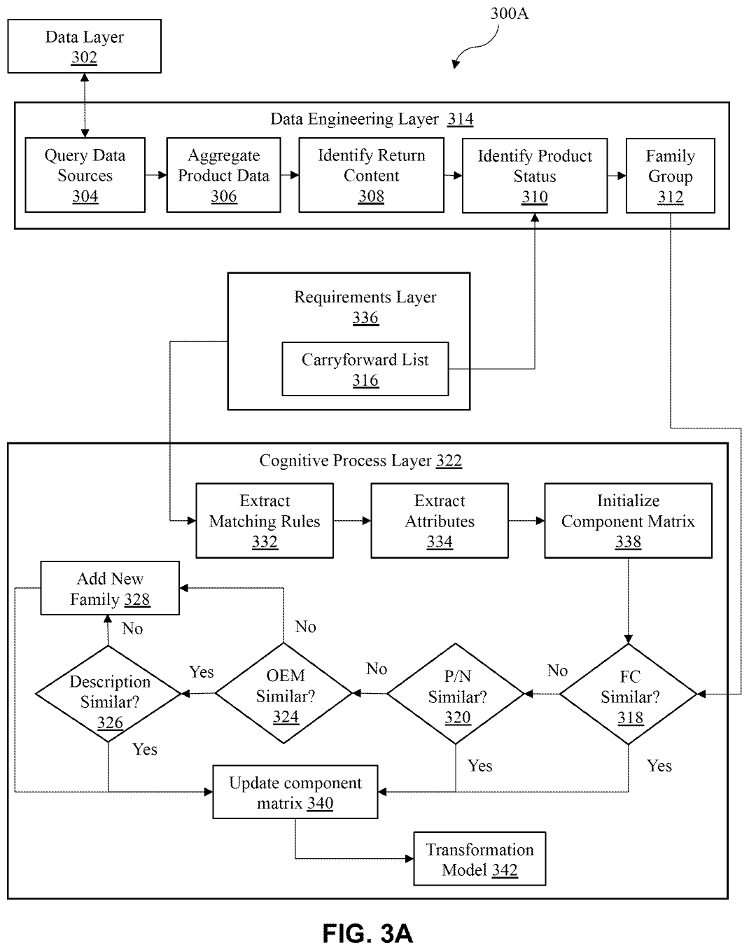

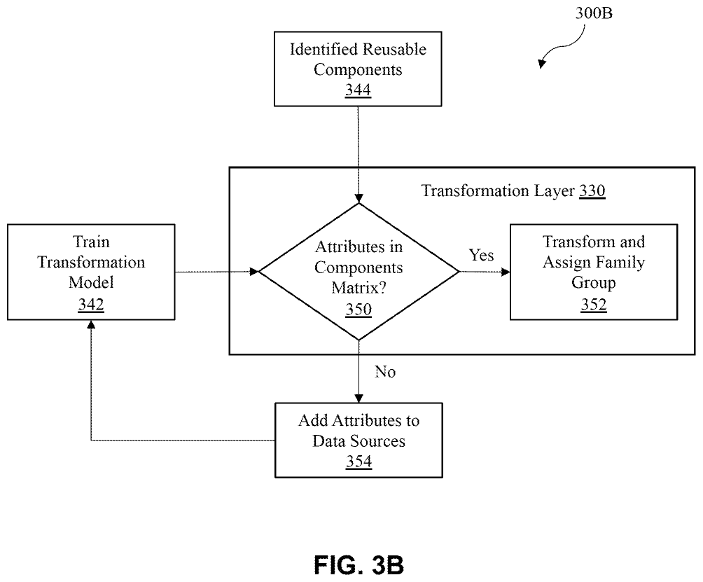

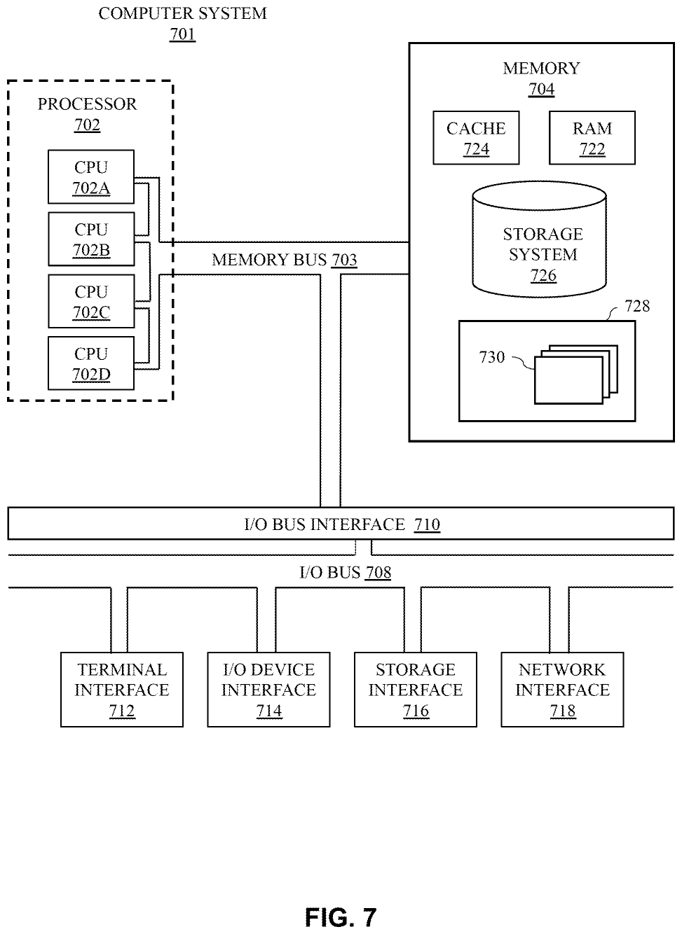

With reference now to FIG. 1, shown is a block diagram of an example returned product transformation system 100 in which illustrative embodiments of the present disclosure may be implemented. In the illustrated embodiment, the returned product transformation system 100 includes returned product transformation device 102 that is communicatively coupled to manufacturer 120 via network 150. In embodiments, returned product transformation device 102 and manufacturer 120 may be configured as any type of computer system and may be substantially similar to computer system 701 of FIG. 7. For example, manufacturer 120 may be configured as one or more product data management system hosted on one or more websites, storage systems, servers, and the like. Further examples of product data management systems are described further in FIG. 2, FIG. 3A, and FIG. 3B with respect to various model layers. In some embodiments, the manufacturer 120 may be local to the returned product transformation device 102 itself.

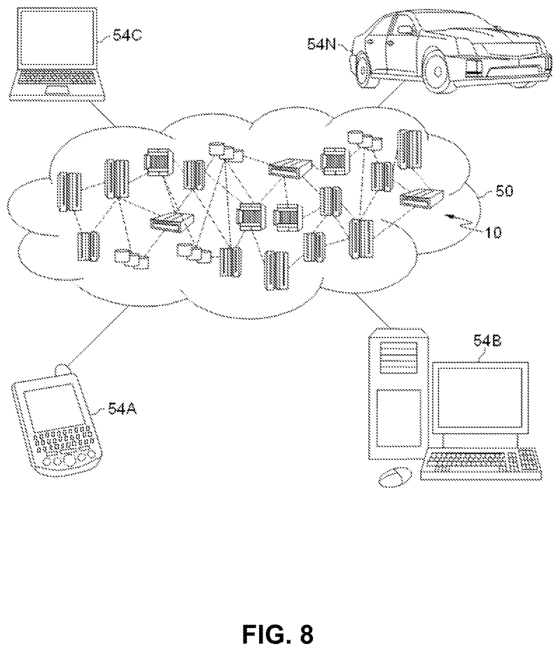

In embodiments, network 150 may be any type of communication network, such as a wireless network, edge computing network, a cloud computing network, or any combination thereof (e.g., hybrid cloud network/environment). Network 150 may be substantially similar to, or the same as, cloud computing environment 50 described in FIG. 8. Consistent with various embodiments, a cloud computing environment may include a network-based, distributed data processing system that provides one or more edge/network/cloud computing services. Further, a cloud computing environment may include many computers (e.g., hundreds or thousands of computers or more) disposed within one or more data centers and configured to share resources (e.g., return product data, product data, etc.) over network 150.

In some embodiments, network 150 can be implemented using any number of any suitable communications media. For example, the network may be a wide area network (WAN), a local area network (LAN), an internet, or an intranet. In certain embodiments, the various systems may be local to each other, and communicate via any appropriate local communication medium. For example, returned product transformation device 102 may communicate with manufacturer 120 using a WAN, one or more hardwire connections (e.g., an Ethernet cable), and/or wireless communication networks. In some embodiments, the various systems may be communicatively coupled using a combination of one or more networks and/or one or more local connections. For example, in some embodiments returned product transformation device 102 may communicate with manufacturer 120 through a wireless communication network or hardwired connection.

In embodiments, returned product transformation device 102 includes processor 106 and memory 108. The returned product transformation device 102 may be configured to communicate with manufacturer 120 through an internal or external network interface 104. The network interface 104 may be, e.g., a modem or a network interface card. The returned product transformation device 102 may be equipped with a display or monitor. Additionally, the returned product transformation device 102 may include optional input devices (e.g., a keyboard, mouse, scanner, or other input device), and/or any commercially available or custom software (e.g., browser software, communications software, server software, natural language processing/understanding software, search engine and/or web crawling software, filter modules for filtering content based upon predefined parameters, etc.).

In some embodiments, the returned product transformation device 102 may include transformation engine 110, machine learning (ML) engine 112, and natural language processing (NLP) system 114.

In embodiments, the transformation engine 110 is configured create a data-driven model to quantify the amount of reusable components in each returned configurable product. The transformation engine 110 may collect returned product data 124 from return processing 122. The returned product data 124 may include identification data related to a returned configurable product. For example, the returned product data 124 may include various attributes associated with various components of the returned configurable product such as serial numbers, feature codes, part numbers, descriptions of each component, functions of each component, reasons why the configurable product was returned, damaged components, etc. The transformation engine 110 may analyze the attributes of each component of the returned configurable product and identify which components of the returned configurable product are reusable. In embodiments, the transformation engine 110 may utilize various modeling layers to make decisions on which components are reusable. The various modeling layers are further described in FIG. 2, FIG. 3A, and FIG. 3B. Once the reusable components are identified, the transformation engine may quantify the overall availability of components in return inventory which can be used to generate new configurable products. In embodiments, the transformation engine 110 may further generate a components matrix which may group components based on similarities. For example, the components matrix may include family groupings based on similar feature codes of the reusable components and current components in inventory. In some embodiments, feature codes and/or part numbers may be merged if they are determined to be similar. For example, part numbers of various components may change over time as the generation of the configurable product changes (e.g., new version of the product, new manufacturer, etc.). The transformation engine 110 may identify that reusable components may be similar based on correlation of their attributes such as feature codes or descriptions are the same even if their part numbers are different. If determined to be similar, the transformation engine 110 may merge or modify the part numbers of the reusable component into a current part number for a similar current component.

In embodiments, the transformation engine 110 may utilize NLP system 114 to analyzing unstructured textual data associated with the returned product data 124. This may include analyzing various product information data, such as manuals, parts listings, feature codes, instruction booklets, etc., that are associated with the returned configurable product. For example, the NLP system may be used to identify similarities of various features by analyzing descriptions of the components of the returned configurable product with respect to current components.

In some embodiments, ML engine 112 may be configured to utilize machine learning algorithms to improve the capabilities of transformation engine 110 without procedural programming. For example, the ML engine 112 may analyze the accuracy of the matching attributes determinations for various reusable components with respect to current comments that were determined to be similar. ML engine 112 may determine that confidence values for the matching the attributes are low and that further adjustment/modification to transformation modeling may be required. ML engine 112 may automatically adjust algorithms of the transformation model for matching the attributes until accuracy values increase. Further, ML engine 112 may utilize various algorithms to aide in identifying attributes associated with the reusable components. For example, ML engine 112 may use image recognition algorithms to identify attributes through visual inspection, verification, identification.

In embodiments, machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

It is noted that FIG. 1 is intended to depict the representative major components of an exemplary returned product transformation system 100. In some embodiments, however, individual components may have greater or lesser complexity than as represented in FIG. 1, components other than or in addition to those shown in FIG. 1 may be present, and the number, type, and configuration of such components may vary.

For example, while FIG. 1 illustrates a returned product transformation system 100 with a single returned product transformation device 102, a single manufacturer 120, and a single network 150, suitable computing environments for implementing embodiments of this disclosure may include any number of returned product transformation systems, devices, manufacturers, and networks. The various modules, systems, and components illustrated in FIG. 1 may exist, if at all, across a plurality of returned product transformation systems, devices, manufacturers, and networks.

Referring now to FIG. 2, shown are example model layers 200 for processing the returned configurable product, in accordance with some embodiments of the present disclosure. In embodiments, model layers 200 may be utilized by returned product transformation device 102 to process a retuned configurable product to identify reusable components. In the illustrated embodiment, model layers 200 include data layer 202, data engineering layer 214, cognitive process layer 222, transformation layer 230, and requirements layer 236.

Returned product transformation device 102 and/or transformation engine 110 may collect various product data (e.g., returned product data 124 and current product data 130) from data sources located on data layer 202. Data sources may comprise various product data systems of manufacturer 120 of FIG. 1.

In embodiments, data layer 202 may include manufacturing floor management system (FMS) 204, manufacturing material requirements planning (MRP) 206, regeneration tool 208, manufacturing order management system (OMS) 210, and product data management (PDM) 212. The collected product data may be used to make determinations on what components of a returned configurable product are reusable for generating other/new configurable products.

Manufacturing FMS 204 may include product data associated with current component inventories available for generating configurable products. For example, product data collected from manufacturing FMS 204 may include various attributes such as serial numbers, feature codes, part numbers, descriptions, and/or floor locations of current components (including reusable components from other returned configurable products) that are available in inventory on the manufacturing floor.

Manufacturing MRP 206 may include product data indicating what type of configurable products are planned to be generated by manufacturer 120. For example, product data collected from manufacturing MRP 206 may indicate required materials and/or components that are used in current generations or versions of configurable products being produced by manufacturer 120. These required materials may be used to determine what components of the returned configurable product are reusable.

Regeneration tool 208 may be configured to identify reusable components from a returned configurable product. This may be performed by analyzing attributes associated with each component of the returned configurable product and correlating which components are substantially similar (e.g., functional similarities, descriptions, etc.) to current components in inventory that are being used for configurable product generation.

Manufacturing OMS 210 may include product data indicating current orders by clients related to new configurable products. The product data may be used to make determinizations on what components are required by the manufacturer 120 and which components are considered to be reusable from the returned configurable product. Manufacturing OMS 210 may include return processing 122 that processes returned product data 124. This may include tracking identification data associated with any returned configurable products. In some embodiments, Manufacturing OMS 210 may also include tracking data related to various alterations of attributes associated with components/reusable components due to maintenance, upgrades, downgrades, etc.

PDM 212 is configured to manage the lifecycle of product data. This may include tracking configuration changes, part number changes, feature code changes, and/or description changes of various components used for generating configurable products.

In embodiments, data engineering layer 214 includes an extracting component 216, a merging component 218 and an aggregation component 220. Extracting component 216 may be configured to extract identification data associated with the returned configurable product. This may be done by extracting and analyzing attributes associated with each component of the returned configurable product. Merging component 218 is configured to merge attributes of reusable components with attributes of current components when generating a components list. Aggregation component 220 is configured to aggregate the reusable components and current components chronologically by attributes in the components list. This may include aggregating the components by feature code, part number, description, quantity, function, etc.

In embodiments, cognitive process layer 222 includes filtering component 224, matching rules 226, and transformation model 228. Filtering component 224 is configured to filter components of the components list by structural family groups. For example, using the components list (comprising reusable and current components), the filtering component will group components with similar attributes (e.g., feature codes, part number, descriptions, etc.) into family groups. Family groups may be merged if attributes are determined to be identical. For example, if the feature codes are identical between two structural family groups, the groups will be merged and added to a component matrix. The filtering criteria may be used to generate matching rules 226. Matching rules 226 may be used to train transformation model 228 in making decisions for transforming attributes of reusable components into attributes of current components based on similarity.

In embodiments, transformation layer 230 includes transformation function 232 and restructuring function 234. Transformation function 232 is configured to transform attributes of reusable component of the returned configurable product into attributes of current components for a new configurable product. This maybe performed by using the trained transformation model 228. The restructuring function 234 may perform data restructuring related to the transformation of a given attribute.

In embodiments, requirements layer 236 includes various requirements/requirements data that the reusable components from the return configurable product must meet prior to being used for generating a new configurable product. Requirements layer 236 may include decision data/input from subject matter experts (SMEs) for generating a given configurable product. Data from requirements layer 236 may be processed in conjunction with product data from data layer 202. Requirements layer 236 includes field quality 238, engineering 240, product design 242 and carryforward list 244. Field quality 238 is configured to ensure any reusable components conform to quality standards. This may be determined by analyzing/comparing attributes of resuable components of the returned configurable product with various quality standards for current components set by the manufacturer. Engineering 240 is configured to identify that reusable components may perform necessary functions when used in a new configurable product. This may be performed by analyzing/identifying attributes related to the specific functions and/or features of the returned components and comparing these attributes to required functions of a given new configurable product. Product design 242 may include various design attributes required for a new configurable product. Carryforward list 244 may include a listing of components that may be reused or carried forward for generating configurable products. The carryforward list may be based on various business rules (e.g., costs analysis, profit, depreciation, etc.) for determining which components to reuse and which components to discard.

Referring now to FIG. 3A, shown is an example diagram 300A for processing the returned configurable product, in accordance with some embodiments of the present disclosure. In the illustrated embodiment, data engineering layer 314 is configured to query data sources 304 of data layer 302 to collect product data related to returned configurable products and/or current components in inventory of the manufacturer. The data engineering layer 314 may aggregate product data 306. This may include aggregating the data chronologically based on generation/version of the component or machine type and model of the component. Aggerating the product data chronologically may allow for identification of attribute changes that may have occurred over time. For example, feature codes and/or part numbers may change over time as new components are manufactured or suppliers change.

The data engineering layer 314 may identify returned content 308. This may include identifying attributes of components of a returned configurable product. The attributes of the components may be identified from product data collected from data sources of the data layer 302.

The data engineering layer 314 may collect data from requirements layer 336 to determine what components of the returned configurable product are reusable. This may be performed by correlating the attributes of the components from the returned configurable product with components required on carryforward list 316. Based on the correlation, the data engineering layer 314 can identify a product status 310. This may include identifying the quantity and type (e.g., feature code, part number, description) of reusable components from the returned configurable product that may be used for further configurable product generation. The data engineering layer 314 may group the reusable components by structural family groups 312. Structural family groupings are based on similarities of the component. This may be based on attributes being identical or substantially similar. For example, components with the same feature code may be grouped in a structural family group.

Cognitive process layer 322 may train a transformation model 342 to identify reusable components of the returned configurable product by utilizing a component matrix. The cognitive layer 322 may extract matching rules 332 for making grouping decisions for generating the component matrix. The component matrix is configured to group the reusable components and/or current components in inventory based on similarities of attributes. The matching rules 332 may be based on various component requirements that are collected from requirements layer 336. Using the matching rules 332, the cognitive layer 322 may extract attributes 334 from the current components and initialize the component matrix 338. The cognitive process layer 322 may receive family group 312 and process the attributes of the reusable components.

For example, the cognitive process layer 322 will determine if the feature code of a reusable component is similar to a second feature code of a current component in the component matrix. If “Yes” at step 318, then the cognitive process layer 322 will update the component matrix 340 by adding the reusable component to the given family group. In some embodiments, updating the component matrix may include modifying quantities of the given reusable component in inventory, updating a location of the reusable component, and/or modifying/merging one or more attributes of the reusable component to match attributes of the current components in the component matrix. If “No” at step 318, the cognitive process layer 322 will determine if a part number of the reusable component is similar to a second part number of a current component in the component matrix. If “Yes” at step 320, the cognitive process layer 322 may update the component matrix 340. If “No” at step 320, the cognitive process layer 322 will determine if the Original Equipment Manufacturer (OEM) of the reusable component is similar to a second OEM of a current component in the component matrix. If the OEMs are not similar, “No” at step 328, a new structural family group may be added to the matrix at step 328. If the OEMs are similar, “Yes” at step 324, the cognitive process layer 322 will analyze the description of the reusable component at step 326. If the description of the reusable component is similar to a description of a current component, “Yes” at step 326, the cognitive process layer 322 will update the component matrix 340. If the descriptions are not similar, “No” at 326, then the cognitive process layer 322 will add a new structural family group to the component matrix at step 328. Each reusable component may be analyzed iteratively until all reusable components of the returned configurable product have been processed and added to the component matrix. The updated component matrix 340 may be used to generate a transformation model 342.

Referring now to FIG. 3B, shown is an example diagram 300B of the transformation layer 330 for processing the identified reusable components of the returned configurable product, in accordance with some embodiments of the present disclosure. In embodiments, the transformation model 342 may be continually trained as additional returned configurable products are received. As additional returned configurable products are received, their reusable components are identified as illustrated at step 344. The transformation layer 330 may use the transformation model 342 to determine if attributes of the reusable components are maintained in the components matrix at step 350. If “Yes” at step 350, the components matrix may be updated with the reusable component where it is transformed (e.g., merged, modified, etc.) and assigned a family group at step 352. If “No” at step 350, the attributes of the reusable components may be added to the data sources at step 354, where the attributes of the reusable components are used to retrain the transformation model 342. In this way, the transformation model 342 may be continually retrained when new reusable components identified from a returned configurable product are received during return processing.

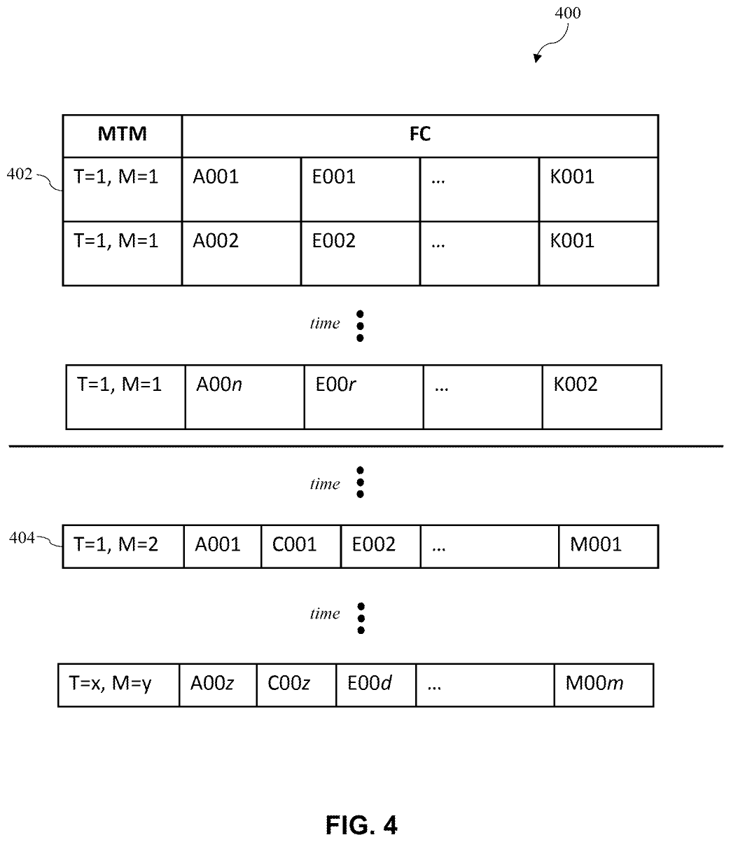

Referring now to FIG. 4, shown is an example machine type and model (MTM) listing 400 of various generations of configurable products over time, in accordance with some embodiments of the present disclosure. In the illustrated embodiment, the listing 400 includes example MTM models and their associated feature codes (FC) for various components of a returned configurable product. As shown, the MTM models include feature codes that change over time (e.g., A001, A002, A00n). However, these feature codes may be considered the same and grouped in the same structural family (e.g., A, E, K, etc.). In embodiments, the returned configurable products may include different components that may be identified based on their given attributes (e.g., feature codes, part numbers (not shown), etc.). For example, returned configurable product 404 includes some similar components based on feature codes A001 and E002 as returned configurable product 402, but also includes different components C001 and M001. In embodiments, the reusable components may be grouped, quantified, clustered, and/or categorized based on their structural/functional similarities of their given attributes.

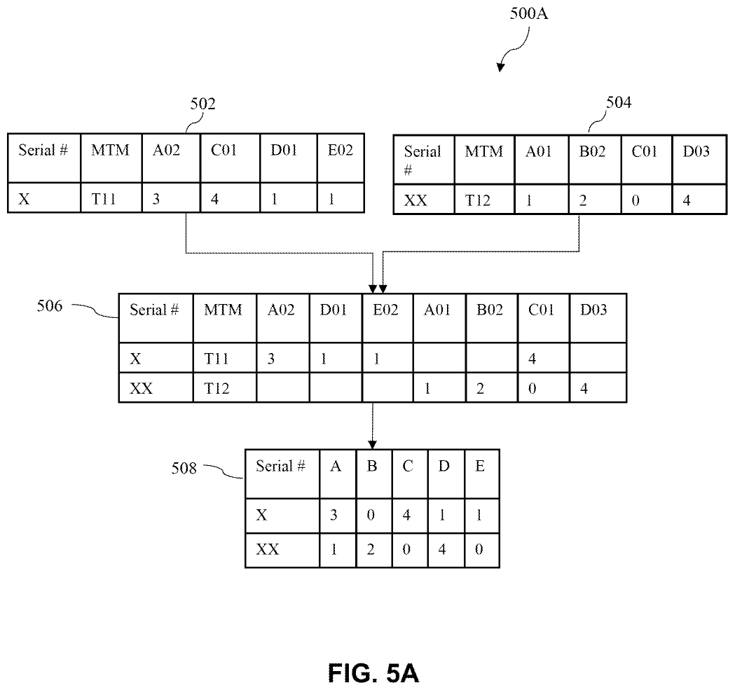

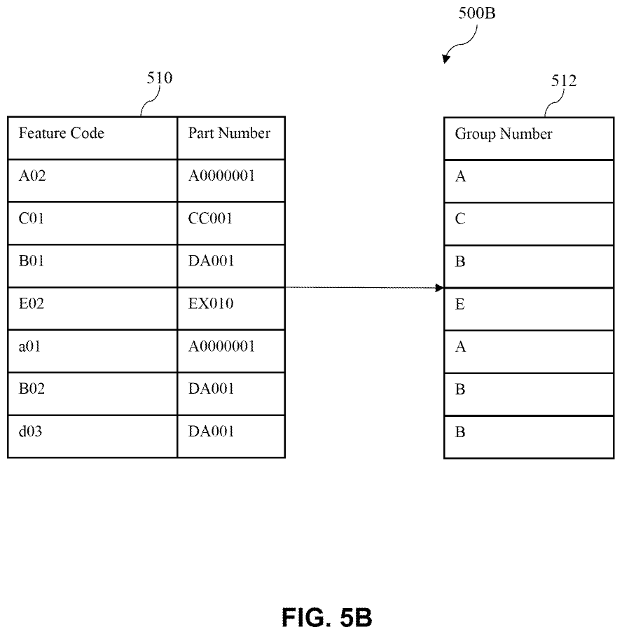

Referring now to FIG. 5A, shown is an example diagram 500A of generating a components list using two different configurable products, in accordance with some embodiments of the present disclosure. In the illustrated embodiment, returned configurable product 502 and returned configurable product 504 may be received and analyzed to identify attributes associated with their various components. In the illustrated embodiment, attributes include serial number, MTM number, quantity of each component, and feature codes. It is noted that this example diagram is not meant to be limiting as more attributes may be identified. A components list 506 may be generated using the identified attributes. The components list 506 may list the quantity of each component based on their respective feature code. For example, serial #X, MTM T11, includes 3 reusable components having feature code A02, 1 reusable component having feature code D01, 1 reusable component having feature code E02, and 4 reusable components having feature code C01.

In embodiments, the components list 506 may be used to generate a component matrix 508. The component matrix 508 may merge various structural family groups together based on similarity. For example, components having feature codes A02 and A01 may be merged together into a structural family group A, while components having feature codes D01 and D03 may be merged together into a structural family group D. This allows for accurate accounting of the quantity of each given component of the return configurable products that are maintained in the return inventory.

Referring now to FIG. 5B, shown is an example diagram 500B of generating a component matrix, in accordance with some embodiments of the present disclosure. In the illustrated embodiment, attribute table 510 includes feature codes and part numbers associated with a plurality of reusable components. In embodiments, the components may be grouped by similarities of their attributes when generating a component matrix 512. For example, components having similar part numbers DA001 may grouped as family group number B since part number DA001 is assigned to a greater number of feature codes having the B designation (B01 and B02 vs. d03). Other factors may be included for grouping assignments, such as age of the component, expiration date of the part number, version, function, etc.

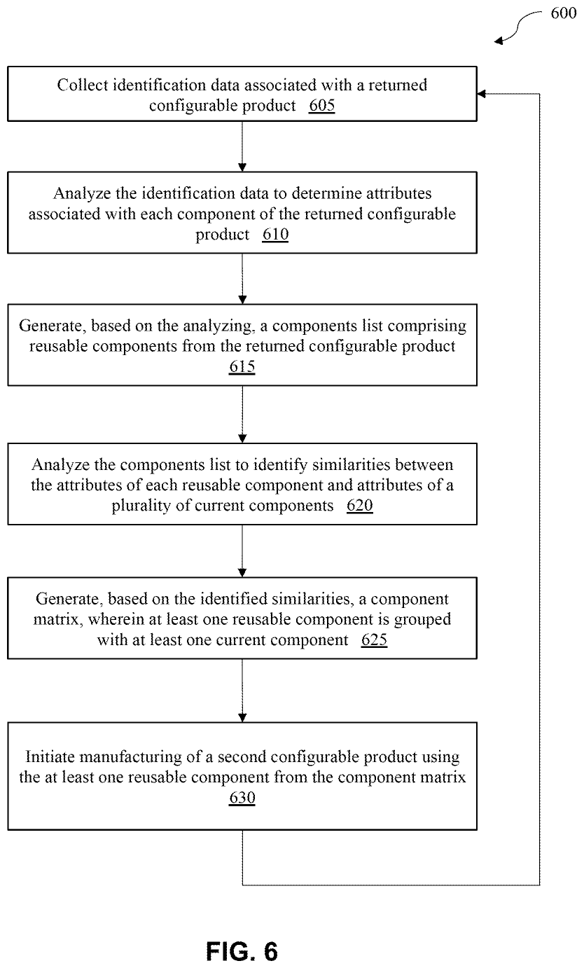

Referring now to FIG. 6, shown is an example process 600 for transforming return content into new content, in accordance with some embodiments of the present disclosure. The process 600 may be performed by processing logic that comprises hardware (e.g., circuitry, dedicated logic, programmable logic, microcode, etc.), software (e.g., instructions run on a processor), firmware, or a combination thereof. In some embodiments, the process 600 is a computer-implemented process. In embodiments, the process 600 may be performed by processor 106 of returned product transformation device 102 exemplified in FIG. 1.

The process 600 begins by collecting identification data associated with a returned configurable product. This is illustrated at step 605. The identification data may be received from a return processing system that process the returned configurable product.

The process 600 continues by analyzing the identification data to determine attributes associated with each component of a plurality of components of the returned configurable product. This is illustrated at step 610. In embodiments, attributes may include any type of identifying information such as a feature code, a part number, a description of the component, and a function of the component. In embodiments, analyzing the identification data may be performed using natural language processing. For example, unstructured textual data from one or more electronic documents associated with the components of the returned configurable product may be received an analyzed to determine identification of the various attributes. For example, various manuals, handbooks, configuration setups, etc., may be analyzing by natural language processing to identify the given attributes.

The process 600 continues by generating, based on the analyzing, a components list comprising a plurality of reusable components from the returned configurable product. This is illustrated at step 615. In some embodiments, location data for each reusable component may be generated for the components list. This location data may be used to track the inventory location of where the reusable components are stored.

In some embodiments, generating the components list may include querying a product data source to determine component requirements for the second configurable product, analyzing the attributes associated with each component of the plurality of components of the returned configurable product, and comparing the attributes associated with each component to a component requirement threshold to identify the plurality of reusable components. The component requirement threshold may be based on various business rules and/or a carryforward list.

The process 600 continues by analyzing the components list to identify similarities between the attributes of each reusable component of the plurality of reusable components and attributes of a plurality of current components. This is illustrated at step 620. In embodiments, the plurality of current components may be other components held in a return inventory or current inventory. For example, the plurality of current components may include at least one reusable component of a second returned configurable product, a new manufactured component, or both. In embodiments, similarities between attributes such as feature code, part number, description of the component, function of the component may be compared. For example, the feature code of each reusable component may be compared to a second feature code of each current component of the components list and any matching feature codes may be identified.

The process 600 continues by generating, based on the identified similarities, a component matrix, wherein at least one reusable component is grouped with at least one current component. This is illustrated at step 625. In embodiments, the component matrix may group components by structural similarities. In some embodiments, grouped components may be merged based on their similarities. For example, a first attribute of at least one reusable component may be modified to a second attribute of at least one current component based on matching feature codes. For example, the first attribute may be a first part number and the second attribute may be a second part number. In this way, reusable components that may have different/older/expired part numbers but belong in the same feature code or structural family group may have their part number's automatically transform to current part numbers.

The process 600 continues by initiating manufacturing of a second configurable product using the at least one reusable component from the component matrix. This is illustrated at step 630. For example, the system may generate a new configurable product using at least one reusable component from the returned configurable product. In some embodiments, the process may return to step 605 in response to a second configurable product being returned. In this way, the process will continually analyze returned products to identify any reusable components.

Referring now to FIG. 7, shown is a high-level block diagram of an example computer system 701 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 701 may comprise one or more CPUs 702, a memory subsystem 704, a terminal interface 712, a storage interface 716, an I/O (Input/Output) device interface 714, and a network interface 718, all of which may be communicatively coupled, directly or indirectly, for inter-component communication via a memory bus 703, an I/O bus 708, and an I/O bus interface 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may include one or more levels of on-board cache. In some embodiments, a processor can include at least one or more of, a memory controller, and/or storage controller. In some embodiments, the CPU can execute the processes included herein (e.g., process 600 as described in FIG. 6). In some embodiments, the computer system 901 may be configured as returned product transformation system 100 of FIG. 1.

System memory subsystem 704 may include computer system readable media in the form of volatile memory, such as random-access memory (RAM) 722 or cache memory 724. Computer system 701 may further include other removable/non-removable, volatile/non-volatile computer system data storage media. By way of example only, storage system 726 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 704 can include flash memory, e.g., a flash memory stick drive or a flash drive. Memory devices can be connected to memory bus 703 by one or more data media interfaces. The memory subsystem 704 may include at least one program product having a set (e.g., at least one) of program modules that are configured to carry out the functions of various embodiments.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single units, the computer system 701 may, in some embodiments, contain multiple I/O bus interfaces 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

One or more programs/utilities 728, each having at least one set of program modules 730 may be stored in memory subsystem 704. The programs/utilities 728 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 728 and/or program modules 730 generally perform the functions or methodologies of various embodiments.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various search servers through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

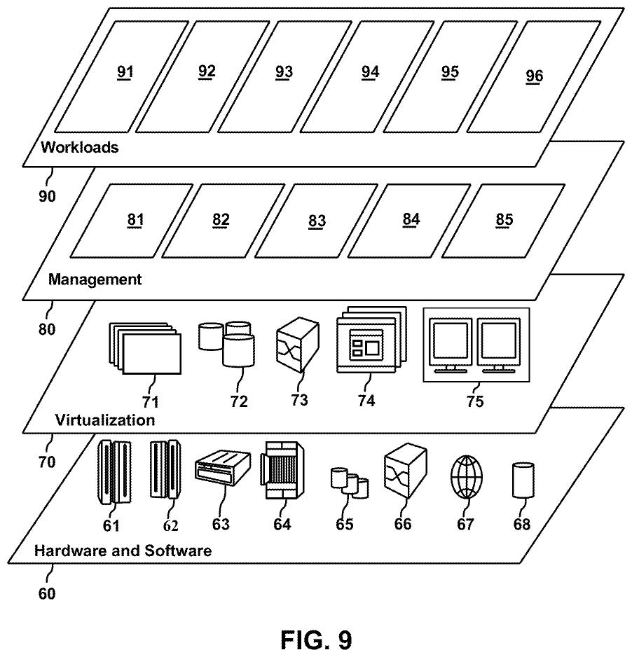

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and returned configurable product software 68 in relation to the returned product transformation device 102 of FIG. 1.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and returned configurable product management and processing 96. For example, returned product transformation device 102 of FIG. 1 may be configured to manage returned configurable products using workloads layer 90.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method comprising:
collecting identification data associated with a returned configurable product;
analyzing the identification data to determine attributes associated with each component of a plurality of components of the returned configurable product;
generating, based on the analyzing, a components list comprising a plurality of reusable components from the returned configurable product;
analyzing the components list to identify similarities between the attributes of each reusable component of the plurality of reusable components and attributes of a plurality of current components;
generating, based on the identified similarities, a component matrix, wherein at least one reusable component is grouped with at least one current component; and
initiating manufacturing of a second configurable product using the at least one reusable component from the component matrix.

2. The computer-implemented method of claim 1, wherein generating the components list comprises:
querying a product data source to determine component requirements for the second configurable product;
analyzing the attributes associated with each component of the plurality of components of the returned configurable product; and
comparing the attributes associated with each component to a component requirement threshold to identify the plurality of reusable components.

3. The computer-implement method of claim 1, wherein the attributes are chosen from a group of attributes consisting of: a feature code, a part number, a description of the component, and a function of the component.

4. The computer-implemented method of claim 3, wherein analyzing the components list to identify similarities between the attributes of the plurality of reusable components and the plurality of current components comprises:
analyzing the feature code of each reusable component with respect to a second feature code of each current component; and
identifying matching feature codes of at least one reusable component and at least one current component.

5. The computer-implemented method of claim 4, wherein generating the component matrix further comprises, modifying a first attribute of the at least one reusable component to a second attribute of the at least one current component based on the matching feature codes.

6. The computer-implemented method of claim 5, wherein the first attribute is a first part number and the second attribute is a second part number.

7. The computer-implemented method of claim 1, wherein analyzing the components list to identify similarities between the attributes of each reusable component of the plurality of reusable components and the attributes of the plurality of current components is performed, in part, using natural language processing.

8. The computer-implemented method of claim 6, wherein the identification data is obtained from an electronic document describing the returned configurable product and analyzed using natural language processing.

9. The computer-implemented method of claim 1, wherein the plurality of current components comprise at least one reusable component of a second returned configurable product, a new manufactured component, or both.

10. The computer-implemented method of claim 1, comprising:
generating location data for each reusable component of the components list; and
tracking a location for each reusable component of the components list.

11. A system comprising:
a processor; and
a computer-readable storage medium communicatively coupled to the processor and storing program instructions which, when executed by the processor, cause the processor to perform a method comprising:
collecting identification data associated with a returned configurable product;
analyzing the identification data to determine attributes associated with each component of a plurality of components of the returned configurable product;
generating, based on the analyzing, a components list comprising a plurality of reusable components from the returned configurable product;
analyzing the components list to identify similarities between the attributes of each reusable component of the plurality of reusable components and attributes of a plurality of current components;
generating, based on the identified similarities, a component matrix, wherein at least one reusable component is grouped with at least one current component; and
initiating manufacturing of a second configurable product using the at least one reusable component from the component matrix.

12. The system of claim 11, wherein generating the components list comprises:
querying a product data source to determine component requirements for the second configurable product;
analyzing the attributes associated with each component of the plurality of components of the returned configurable product; and
comparing the attributes associated with each component to a component requirement threshold to identify the plurality of reusable components.

13. The system of claim 11, wherein the attributes are chosen from a group of attributes consisting of: a feature code, a part number, a description of the component, and a function of the component.

14. The system of claim 13, wherein analyzing the components list to identify similarities between the attributes of the plurality of reusable components and the plurality of current components comprises:
analyzing the feature code of each reusable component with respect to a second feature code of each current component; and
identifying matching feature codes of at least one reusable component and at least one current component.

15. The system of claim 14, wherein generating the component matrix further comprises, modifying a first attribute of the at least one reusable component to a second attribute of the at least one current component based on the matching feature codes.

16. A computer program product comprising a computer-readable storage medium having program instructions embodied therewith, the program instructions executable by a processor to cause the processor to perform a method comprising:
collecting identification data associated with a returned configurable product;
analyzing the identification data to determine attributes associated with each component of a plurality of components of the returned configurable product;
generating, based on the analyzing, a components list comprising a plurality of reusable components from the returned configurable product;
analyzing the components list to identify similarities between the attributes of each reusable component of the plurality of reusable components and attributes of a plurality of current components;
generating, based on the identified similarities, a component matrix, wherein at least one reusable component is grouped with at least one current component; and
initiating manufacturing of a second configurable product using the at least one reusable component from the component matrix.

17. The computer program product of claim 16, wherein generating the components list comprises:
querying a product data source to determine component requirements for the second configurable product;
analyzing the attributes associated with each component of the plurality of components of the returned configurable product; and
comparing the attributes associated with each component to a component requirement threshold to identify the plurality of reusable components.

18. The computer program product of claim 16, wherein the attributes are chosen from a group of attributes consisting of: a feature code, a part number, a description of the component, and a function of the component.

19. The computer program product of claim 18, wherein analyzing the components list to identify similarities between the attributes of the plurality of reusable components and the plurality of current components comprises:
analyzing the feature code of each reusable component with respect to a second feature code of each current component; and
identifying matching feature codes of at least one reusable component and at least one current component.

20. The computer program product of claim 19, wherein generating the component matrix further comprises, modifying a first attribute of the at least one reusable component to a second attribute of the at least one current component based on the matching feature codes.
